(19) United States
(12) Patent Application Publication
(10) Pub. No.: US 2015/0178836 A1
(43) Pub. Date: Jun. 25, 2015

(54) METHOD FOR PROVIDING SECURITY TRANSACTION SERVICE

(71) Applicant: Jung Guem Kim, Seoul (KR)

(72) Inventor: Jung Guem Kim, Seoul (KR)

(21) Appl. No.: 14/408,700

(22) PCT Filed: Jun. 18, 2013
(86) PCT No.: PCT/KR2013/005339

§ 371 Date: Dec. 17, 2014

(30) Foreign Application Priority Data
Jun. 18, 2012 (KR) 10-2012-0065081

(51) Int. Cl. G06Q 40/04

(52) U.S. Cl. CPC G06Q 40/04

(57) ABSTRACT

A security transaction server accepts a security transaction request from a terminal of a security beneficiary and registers the security transaction request in a list of security transaction requests, provides the list of the security transaction requests to a terminal of a security provider to collect security providers, receives contract documents concluded between the security beneficiary and the security provider from the security beneficiary and the security provider and registers the contract documents, establishes a security right by a security request amount of money for a financial asset of the security provider depending on contents of the contract documents, provides the established security right as a financial asset of the security beneficiary, exercises the security right on an expiration date of the security right or depending on a received contract termination request, and provides a dealing money depending on the exercise of the security right to an account of the security beneficiary.

### TECHNICAL FIELD

The present invention relates to a financial service based on a security transaction. More particularly, the present invention relates to a security transaction service method of confirming a fund payment contract depending on provision of goods or services between a security beneficiary requiring a fund and a security provider in a banking sector, generating a fund depending on contract conclusion through a security of the security provider, and providing the fund to the security beneficiary.

### BACKGROUND ART

In a security transaction for business activities of companies, enterprises, individuals, or the like, a supplier that is to provide goods, services, or the like, makes a contract with an investor (that is, a security provider), provides the goods or the services to the investor during a contracted supplying period, receives a security from the investor at the cost of the goods or the services, and recoups an incurred expense using the security.

However, since the security transaction contract between the supplier and the investor as described above is made offline, it is not easy for the supplier to search for the investor, and even though the supplier difficultly searches for the investor and makes a contract with the investor, damage due to contract non-fulfillment often occurs.

Therefore, a method of allowing the supplier providing the goods or the services to easily make a contract with the investor and minimizing occurrence of loss due to the contract non-fulfillment has been demanded.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a security transaction service method having advantages of allowing a security beneficiary providing goods or services to easily make a contract with a security provider and allowing the contract to be stably performed and processed.

Further, the present invention has been made in an effort to provide a security transaction service method having advantages of putting off direct movement of a fund to a future point in time and establishing a security right at the present time to move a fund or allow the fund to be used based on the security right in the future point in time, as a financial transaction means.

### Technical Solution

An exemplary embodiment of the present invention provides a security transaction service method including: (a) a security transaction server accepting a security transaction request from a security beneficiary and registering the security transaction request in a list of security transaction requests; (b) the security transaction server providing the list of the security transaction requests to a security provider; (c) the security transaction server receiving contract documents concluded between the security beneficiary and the security provider from the security beneficiary and the security provider and registering the contract documents; (d) the security transaction server establishing a security right by a security request amount of money for a financial asset of the security provider depending on contents of the contract documents; (e) the security transaction server providing the established security right as a financial asset of the security beneficiary; (f) the security transaction server exercising the security right on an expiration date of the security right or depending on a received contract termination request; and (g) the security transaction server providing a dealing money depending on the exercise of the security right to an account of the security beneficiary.

The security right may be at least one of a pledge, a guarantee, and a performance bond guarantee.

In the step (d), the security right is established by the security request amount of money for a security deposit of the security provider in the case in which a deposit security loaned money of the security provider is the security request amount of money or more, the security right is established by the security request amount of money for a security deposit of the security provider and the balance of a mother account of the security provider in the case in which a deposit security loaned money of the security provider is less than the security request amount of money and a first amount of money corresponding to the sum of the deposit security loaned money of the security provider and the balance of the mother account of the security provider is the security request amount of money or more, or the security right is established by the security request amount of money for the deposit security loaned money, the balance of the mother account, and another security in the case in which the first amount of money is less than the security request amount of money and a second amount of money corresponding to the sum of the deposit security loaned money, the balance of the mother account, and a loaned money obtained using another security is the security request amount of money or more.

The step (a) includes: the security transaction server providing a security transaction request document to the security beneficiary depending on a request of the security beneficiary; and the security transaction server receiving the security transaction request document from the security beneficiary to accept a security transaction request and registering the first security transaction request document in the list of the security transaction requests.

in the step (c), the security transaction server provides and withdraws the contract documents to and from the security beneficiary and the security provider, compares the withdrawn contract documents with each other, and registers the contract documents simultaneously with concluding a contract in the case in which contents of the contract documents coincide with each other.

According to an exemplary embodiment of the present invention, a connection between a supplier providing goods or services and an investor requiring the goods and the services is facilitated.

In addition, according to an exemplary embodiment of the present invention, the supplier (security beneficiary) may use a fund by finance using a security, and the investor (security supplier) may put off final payment to a future point in time in which a supply contract of the goods and the services is certainly fulfilled, thereby allowing stable business activities to be performed.

### Advantageous Effects

According to an exemplary embodiment of the present invention, since a contract is fulfilled through a banking sector, the supplier (security beneficiary) may stably and rapidly collect a selling money, may not substantially have a cost required for collecting the selling money, and may minimize loss depending on cancellation of the contract.

In addition, according to an exemplary embodiment of the present invention, since the contract is fulfilled in a stated in which the selling money is provided as a security to the banking sector, the investor may have an effect of putting off a payment completion time of the selling money, have an opportunity capable of sufficiently evaluating satisfaction or a value for goods even after the contract, and minimize loss depending on cancellation of the contract.

### DESCRIPTION OF THE DRAWINGS

FIG. 1 is a flow chart showing schematic processes of a security transaction service method according to an exemplary embodiment of the present invention.

FIG. 2 is a block diagram of a security transaction service system according to an exemplary embodiment of the present invention.

FIG. 3 is a detailed configuration diagram showing configurations of main units of the security transaction service system according to an exemplary embodiment of the present invention.

FIG. 4 is a flow chart showing a contract conclusion process between a security beneficiary and a security provider in the security transaction service method according to an exemplary embodiment of the present invention.

FIG. 5 is a flow chart showing a process of providing a security of the security provider to the security beneficiary in the security transaction service method according to an exemplary embodiment of the present invention.

FIG. 6 is a flow chart showing a processing process depending on contract non-fulfillment in the security transaction service method according to an exemplary embodiment of the present invention.

FIG. 7 is a flow chart showing a security deposit canceling process in a security right exercising process in the security transaction service method according to an exemplary embodiment of the present invention.

FIG. 8 is a flow chart showing a guarantee processing process in the security right exercising process in the security transaction service method according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

Hereinafter, a security transaction service method according to an exemplary embodiment of the present invention will be described in detail with reference to the accompanying drawings.

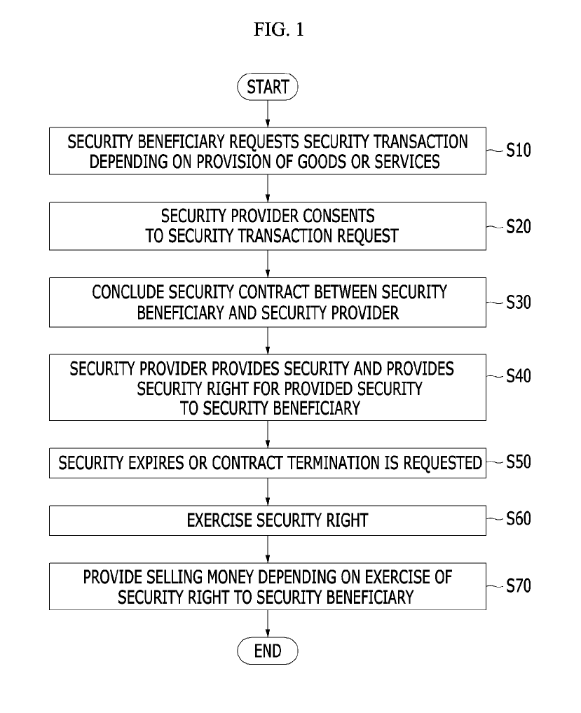

FIG. 1 is a flow chart showing schematic processes of a security transaction service method according to an exemplary embodiment of the present invention. As shown in FIG. 1, the security transaction service method according to an exemplary embodiment of the present invention is performed by an Internet server (hereinafter, referred to as a “security transaction server”) operated by a banking sector, a non-banking sector, or the like.

Hereinafter, in order to assist in the understanding, a supplier providing goods or services is called a security beneficiary, and an investor receiving and using the goods or the services and providing a security at the cost of the goods or the services is called a security provider.

A security transaction server receives information on the goods or the services, various information on the security beneficiary or an enterprise managed by the security beneficiary, and various condition information for a security transaction contract from the security beneficiary and registers a security transaction request of the security beneficiary to request collection of security providers (S10).

The security transaction server provides security transaction collection contents of the security beneficiary depending on requests of all persons or members accessing the security transaction server to allow accessors to confirm the security transaction collection contents, and registers an investor consenting to the security transaction as a security provider at the time of consenting to the security transaction request (S20).

Here, in the case in which the number of persons consenting to the security transaction request is one or more, information on the consenting persons and adjustment information (adjustment information such as a price, a payment condition, a security providing method, and the like) of the security transaction request may be provided to the security beneficiary to allow the security beneficiary to select one of the consenting persons. The security transaction server may select one of the persons consenting to the security transaction request based on response information, a credit state of the consenting person, the adjustment information, or the like.

When the security provider is registered, the security transaction server provides contract documents to each of the security beneficiary and the security provider to allow a contract to be concluded between the security beneficiary and the security provider, and stores the contract document (S30).

When the contract conclusion is completed, the security transaction server confirms financial assets (for example, a time deposit, the balance of a general bankbook, a guarantee or a security right received from a third party, and the like) depending on identification of the security provider, establishes a security right by a contract amount of money (an amount of money requested by the security beneficiary at the cost of provision of the goods or the services, that is, a security request amount of money) written on the contract document, and provides the established security right to the security beneficiary (S40).

Here, the security right is at least one of a pledge, a guarantee, and a performance bond guarantee. For example, in the case of a deposit bond, the pledge is established as the security right, and in the case of other securities, the guarantee or the performance bond guarantee is established as the security right.

When a security period expires or a contract termination request is accepted (S50), the security transaction server exercises the security right provided to the security beneficiary to exercise or return the security right provided to the security beneficiary (S60).

The exercise of the security right, which is a procedure of allowing a predetermined security to be changed into an amount of money, is to cancel a deposit in the case in which the security is the deposit, is to settle the balance of a general bankbook in the case in which the security is the general bankbook account, and is to demand guarantee fulfillment, extinguish a guarantee simultaneously with receiving the demand for the guarantee fulfillment, and settle the guarantee as a guarantee fulfillment money in the case in which the security is the guarantee.

When an amount of money occurs depending on the exercise of the security right, the security transaction server provides the amount of money occurring depending on the exercise of the security right to the security beneficiary (S70).

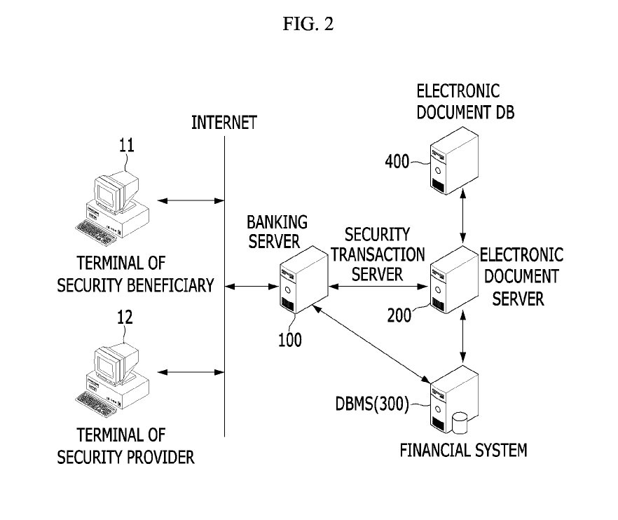

Hereinafter, a security transaction service system providing the security transaction service method according to an exemplary embodiment of the present invention will be described with reference to FIG. 2.

FIG. 2 is a block diagram of a security transaction service system according to an exemplary embodiment of the present invention. As shown in FIG. 2, the security transaction service system according to an exemplary embodiment of the present invention is based on a system built by a financial institution.

That is, the security transaction service system is configured to include a security transaction server 100, an electronic document server 200, a database management system (DBMS) 300, and an electronic document DB 400.

The security transaction server 100 is operated as a subject performing the security transaction service method according to an exemplary embodiment of the present invention. The security transaction server 100 provides a financial service in connection with a core banking system of a financial legacy system as well as a function as an Internet server.

In detail, the security transaction server 100 connects a terminal of a security beneficiary 11 and a terminal of a security provider 12 to each other through the Internet, and provides a security transaction relay service so that a security transaction agreement between the security beneficiary 11 and the security provider 12 is possible.

Here, the security beneficiary 11 and the security provider 12 are members of the security transaction server 100, and are in a state in which they open their mother accounts, security aggregation accounts, and related loan accounts with a bank managing the security transaction server 100, respectively.

Here, the mother account is an account for provision of the security, receipt of the security, repayment or interest payment of a security related loan, an inflow of an investment fund of the security beneficiary 11, receipt of a loan fund at the time of security transaction, deposit of an accident report money, and the like. A fund for the security transaction is generally managed through the mother account. The mother account has a feature of a demand account through which a money is freely deposited and withdrawn.

The security aggregation account is an account for managing the security (the fund or the security right) received by the security beneficiary 11. Here, the security right includes a guarantee (guarantee number). The related loan account is an account for managing a loan received by the security beneficiary 11 based on the security aggregation account.

For the purpose of a security transaction relay service, the security transaction server 100 receives and registers a security transaction request from the security beneficiary 11 and provides a list of the registered security transaction requests to the security provider 12. In addition, for the purpose of the security transaction relay service, the security transaction server 100 provides contract documents to the security beneficiary 11 and the security provider 12 wanting to make a security transaction contract to allow the contract to be concluded, and registers and manages the concluded contract documents.

In addition, the security transaction server 100 provides a security transaction exercise service based on the concluded contract documents. For the purpose of the security transaction exercise service, the security transaction server 100 establishes a security right using a security request amount of money in a financial asset of the security provider 12 as a security based on contracted contents in the contract document and provides the established security right to the security beneficiary 11. The security right is established after the security provider 12 receives goods and/or services coinciding with the contracted contents in the contract document from the security beneficiary 11, and this fact is confirmed by the security provider 12 informing the security transaction server 100 that he/she receives the goods and/or the services from the security beneficiary 11.

When a contract termination request is received from the security beneficiary 11 and the security provider 12 or a date becomes a security expiration date written on the contract document, the security transaction server 100 exercises the security right to provide a security request amount of money to the security beneficiary 11 and extinguish the security right.

Meanwhile, the security transaction server 100 performs a contract non-fulfillment processing in the case in which the financial asset of the security provider 12 is smaller than the security request amount of money on the contract document at the time of establishing or exercising the security right. As the contract non-fulfillment processing operation, a general procedure according to loaned money repayment arrears conducted in a general banking sector is performed.

The electronic document server 200, a financial system (including the DBMS 300), the electronic document DB 400, and the banking server are components configuring a system at the time of a financial transaction. Here, the financial system generally indicates an apparatus (server) and a system except for the electronic document server 200, the electronic document DB 400, and the banking server in the financial legacy system.

The electronic document server 200 and the electronic document DB 400 are to store information indicating to what financial product the security beneficiary 11 and the security provider 12 subscribe as a document. The electronic document server 200 receives an electronic document for an opened account or a security transaction contract document from the security transaction server 100 to create electronic document information, and the electronic document DB 400 stores the electronic document information created by the electronic document server 200.

The DBMS 300 receives various information related to a security transaction from the security transaction server 100 to creates/stores a ledger, stores various information on customers opening the account or the concerned parties (the security beneficiary and the security provider) making a contract for the security transaction, and stores various financial information generated in association with the security transaction.

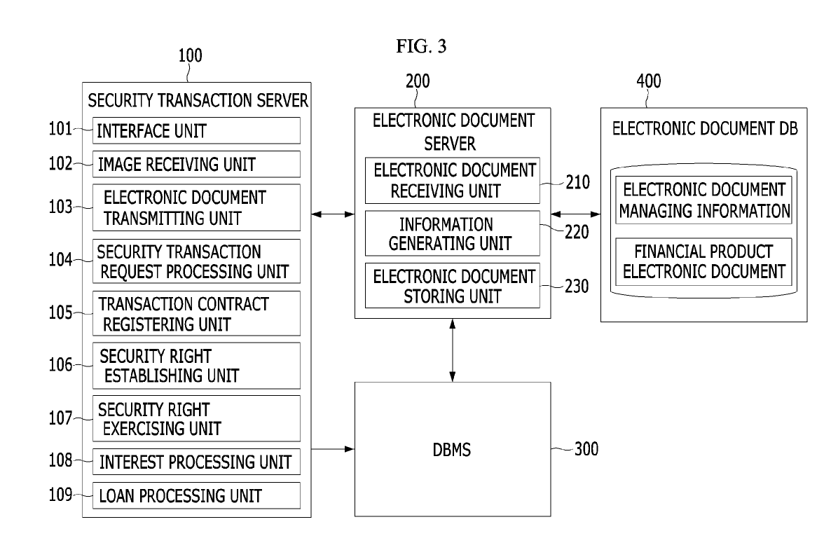

Hereinafter, each server 100 to 400 shown in FIG. 2 will be described in detail with reference to FIG. 3. FIG. 3 is a detailed configuration diagram showing configurations of main units of the security transaction service system according to an exemplary embodiment of the present invention.

The security transaction server 100 is configured to include an interface unit 101, an image receiving unit 102, an electronic document transmitting unit 103, a security transaction request processing unit 104, a transaction contract registering unit 105, a security right establishing unit 106, a security right exercising unit 107, an interest processing unit 108, and a loan processing unit 109.

The interface unit 101 supports a connection between the terminal of the security beneficiary 11 and the terminal of the security provider 12 through the Internet and supports an interface with a window terminal (not shown) through a financial network (or a local network). In addition, the interface unit 101 connects the system according to the present invention to various servers 200 and 300 to enable data communication. Here, the interface provided by the interface unit 101 is based on a protocol stack defined in a communication network that it accesses.

The image receiving unit 102 receives an image content (for example, an image file) of a subscription application document of various accounts or a security transaction contract document of the security beneficiary 11 received through the interface unit 101.

Here, in the subscription application document of the account, customer information such as personal information of a customer, or the like, subscription information provided by a corresponding financial company and informing the customer of subscription to the account, and account operation condition information are written.

As a content of the security transaction contract document, identification information (for example, a resident registration number, a bank account number, or the like) of the security beneficiary, identification information (for example, a resident registration number, a bank account number, or the like) of the security provider, an electronic signature, and the like, are written, and various details of enterprise information, payment condition information, product delivery condition information, and supply condition information are certainly written.

The enterprise information is a trade name, an address, a business registration number, a type of business, a business status, or the like, of a company (an enterprise, a store, or the like) managed by the security beneficiary 11 or the security provider 12, and the payment condition information is product unique information such as a product name, a quantity, a specification, a product description, a product describing number, or the like, a unit price, a supply price, a tax, a payment method (for example, one of payment in a lump sum, payment by installment, and payment depending on a condition) of a product, or the like. The product delivery condition information is a product deliver time, a deliver place, a return time, a return place, a penalty for breach of contract, or the like, and the supply condition information is a security providing method (for example, one of usance and installment), a kind of security (for example, at least one of a money, a guarantee, and the like), a security deposit interest rate, a beneficiary security providing amount of money of the security beneficiary, a security providing expiration, or the like.

The electronic document transmitting unit 103 creates the respective electronic documents using the image content of the subscription application document of the account and an image content of a security transaction contract document and transmits the created electronic documents to the electronic document server 200.

The security transaction request processing unit 104 provides a security transaction request document depending on the security transaction request received from the security beneficiary 11, matches information written in the security transaction request document to the identification information of the security beneficiary, stores the matched information, and registers the stored information in a list of the security transaction requests.

In the security transaction request document, the enterprise information such as the trade name, the address, the business registration number, the type of business, the business status, or the like, of the company (the enterprise, the store, or the like) managed by the security beneficiary 11, the payment condition information such as the product unique information, for example, the product name, the quantity, the specification, the product description, the product describing number, or the like, the unit price, the supply price, the tax, the payment method (for example, the payment in a lump sum, the payment by installment, or the payment depending on a condition) of a product, or the like, the product delivery condition information such as the product deliver time, the deliver place, the return time, the return place, the penalty for breach of contract, or the like, and the supply condition information such as the security providing method (for example, one of the usance and the installment), the kind of security (for example, the money, the guarantee, or the like), the security deposit interest rate, the beneficiary security providing amount of money of the security beneficiary, the security providing expiration, or the like, are written.

Meanwhile, in the case in which the security transaction request processing unit 104 stores and manages a black list for a security transaction suspension subject, the security transaction request processing unit 104 disallows the security transaction request when the security beneficiary 11 is the security transaction suspension subject and allows the security transaction request when the security beneficiary 11 is not the security transaction suspension subject.

When the accessor requests the list of the security transaction requests, the security transaction request processing unit 104 provides the list of the security transaction requests to an accessor, and provides a content of the security transaction request document for a transaction request case selected by the accessor among items of the list of the security transaction requests to the accessor. The security transaction requst processing unit 104 selects one of the security transaction request cases by the accessors and registers an accessor consenting to the transaction as the security provider 12 of the corresponding security transaction request case.

When the security provider 12 for the security transaction request case is registered, the transaction contract registering unit 105 provides and withdraws contract documents to and from both of the security provider 12 and the security beneficiary 11, compares contents of the withdrawn contract documents with each other, and registers contract conclusion in the case in which the contents are the same as each other. Here, the registered contract documents are stored and managed as electronic documents in the DBMS 300.

The security right establishing unit 106 establishes a security for the contract-concluded contract document. That is, the security right establishing unit 106 calculates a value of a deposit, a mother account, and another security of the security provider 12 as a valuation amount, decides whether the valuation amount is higher than a security request amount of money of a corresponding contract, establishes a security right for at least one of the deposit, the mother account, and another security in the case in which the valuation amount is higher than the security request amount of money, and provides the security right to the security beneficiary 11. In the case in which the valuation amount of the deposit, the mother account, and another security of the security provider 12 is lower than the security request amount of money, the security right establishing unit 106 increases the valuation amount by a financial method such as a loan, or the like, and then establishes the security right or informs the security beneficiary 11 that the contract is canceled in the case in which the security right may not be established even by the financial method such as the loan, or the like.

According to an exemplary embodiment of the present invention, the security transaction server 100 may find out whether or not the security provider 12 may provide the security request amount of money before a contract is made between the security beneficiary 11 and the security provider 12 and allow the contract to be concluded only in the case in which the security provider 12 may provide the security request amount of money.

In the case in which a date becomes a security expiration date written on the contract document or contract cancellation is requested from the security beneficiary 11 and the security provider 12, the security right exercising unit 107 exercises the security right to generate the security request amount of money corresponding to the security of the security provider 12 and provides the security request amount of money to the security beneficiary 11. The security right exercising unit 107 confirms loan information of the security beneficiary 11 at the time of exercising the security right to confirm whether or not the loan has been generated using the security right, and provides only a remaining amount of money (remainder amount of money) except for a loaned amount of money in the security request amount of money to the security beneficiary 11 in the case in which the loan is generated.

The interest processing unit 108 calculates an interest at the time of exercising the security right with respect to the security of the security provider 12, that is, a financial product generating an interest, such as the deposit, or the like, searches for a person to which the calculated interest is to be provided, and provides the corresponding interest to the corresponding person (the security beneficiary or the security provider).

The loan processing unit 109 confirms loan related information of the security beneficiary 11 or the security provider 12 and generates a general loan for the security beneficiary 11 or the security provider 12, if necessary.

The electronic document server 200, which is a server included in the financial legacy system, allows the financial legacy system to store and manage subscription information or contract information on a financial product (for example, a deposit, a general account, a security transaction, or the like) to which a subscriber subscribes as an electronic document.

The electronic document server 200 is configured to include an electronic document receiving unit 210, an information generating unit 220, and an electronic document storing unit 230.

The electronic document receiving unit 210 receives a financial product electronic document including an image content, provided by the electronic document transmitting unit 103 of the security transaction server 100.

The information generating unit 220 generates a predetermined electronic document unique number (unique information) that is to be allocated to the financial product electronic document received through the electronic document receiving unit 210 and electronic document managing information including electronic document storing date and time information including a date and a time in which the financial product electronic document is received through the electronic document receiving unit 210 (or a date and a time in which the financial product electronic document is stored).

The electronic document storing unit 230 stores the electronic document unique information and the electronic document managing information generated by the information generating unit 220 in the electronic document DB 400.

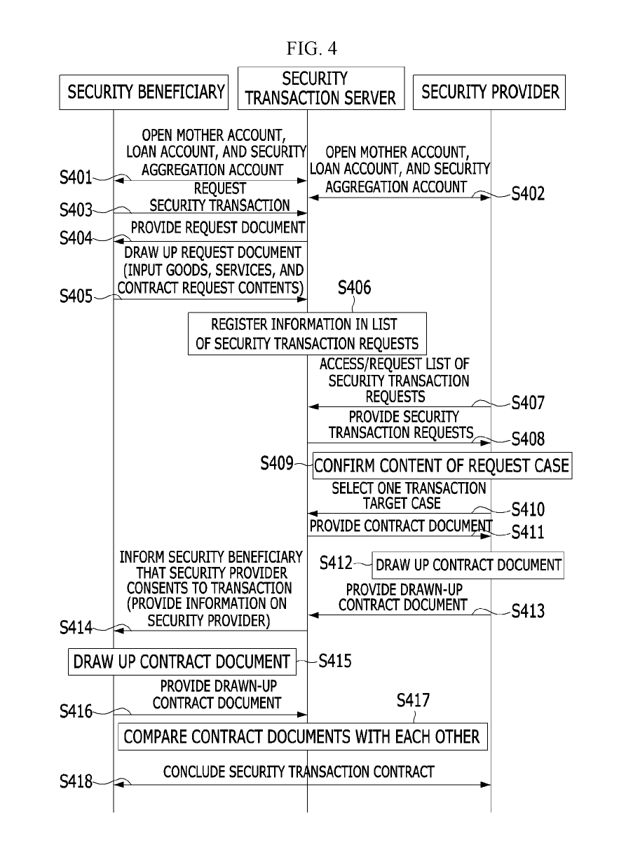

Hereinafter, the security transaction service method according to an exemplary embodiment of the present invention will be described with reference to FIG. 4. FIG. 4 is a flow chart showing a contract conclusion process between a security beneficiary and a security provider in the security transaction service method according to an exemplary embodiment of the present invention.

The security beneficiary 11 and the security provider 12 accesses the security transaction server 100 to open mother accounts, loan accounts, and security aggregation accounts (S401 and S402).

The security beneficiary 11 accesses the security transaction server 100 to request the security transaction (S403). Therefore, the security transaction server 100 provides the security transaction request document to the security beneficiary 11 (S404).

The security beneficiary 11 writes product information on goods or services, enterprise information, payment condition information, product delivery condition information, supply condition information, personal information, and the like, in the security transaction request document and provides the security transaction request document to the security transaction server 100 (S405), and the security transaction server 100 matches each information of the received security transaction request document with identification information of the security beneficiary 11, stores the matched information, and then registers the stored information in a list of security transaction requests (S406).

When the security provider 12 accesses the security transaction server 100 to request the list of the security transaction requests (S407), the security transaction server 100 provides the list of the security transaction requests to the security provider 12 (S408).

The security provider 12 selects a case that is to be confirmed among details of the list of the security transaction requests to receive a content of the corresponding transaction target case from the security transaction server 100 and confirm the received content (S409), and selects one transaction target case that he/she wants to make a contract to request the contract (S410).

Therefore, the security transaction server 100 provides a contract document to the security provider 12 (S411), and withdraws the contract drawn up by the security provider 12 (S412 and S413).

In the security transaction contract document drawn up by the security provider 12, the identification information (for example, the resident registration number, the bank account number, or the like) of the security beneficiary, the identification information (for example, the resident registration number, the bank account number, or the like) of the security provider, the electronic signature, and the like, are written, and various details of the enterprise information, the payment condition information, the product delivery condition information, and the supply condition information are certainly written.

The security transaction server 100 informs the security beneficiary 11 that the security provider 12 consents to the transaction and provides the contract document to the security beneficiary 11 (S414).

Here, the security transaction server 100 provides the contract document drawn up by the security provider 12 to the security beneficiary 11 to allow the security beneficiary 11 to confirm a contract condition of the security provider 12, thereby allowing the contract condition to be adjusted between the security provider 12 and the security beneficiary 11.

The security beneficiary 11 draws up the contract document received from the security transaction server 100 (S415). Here, as contents of the drawn-up contract document, remaining information other than the enterprise information and the personal information, that is, the payment condition information, the product delivery condition information, the supply condition information, and the like, are similarly drawn up in the contract document provided by the security provider 12.

The security transaction server 100 receives the contract document drawn up by the security beneficiary 11 (S416), and compares the received contract document with the contract document drawn up by the security provider 12 in order to confirm whether or not the contract documents are the same as each other (S417).

In the contract document of the security provider 12 and the contract provider of the security beneficiary 11, the identification information (for example, names, resident registration numbers, and the like) of the security provider 12 and the security beneficiary 11 capable of recognizing that a contract is a contract between the security provider 12 and the security beneficiary 11 are written.

When contract contents of the contract document of the security beneficiary 11 and the contract document of the security provider 12 are the same as each other, the security transaction server 100 decides that the contract has been concluded to register these contract documents as security transaction contract documents (S418). When the contract contents of the contract document of the security beneficiary 11 and the contract document of the security provider 12 are not the same as each other, the security transaction server 100 informs the security beneficiary 11 and the security provider 12 that the contract contents of the contract document of the security beneficiary 11 and the contract document of the security provider 12 are not the same as each other.

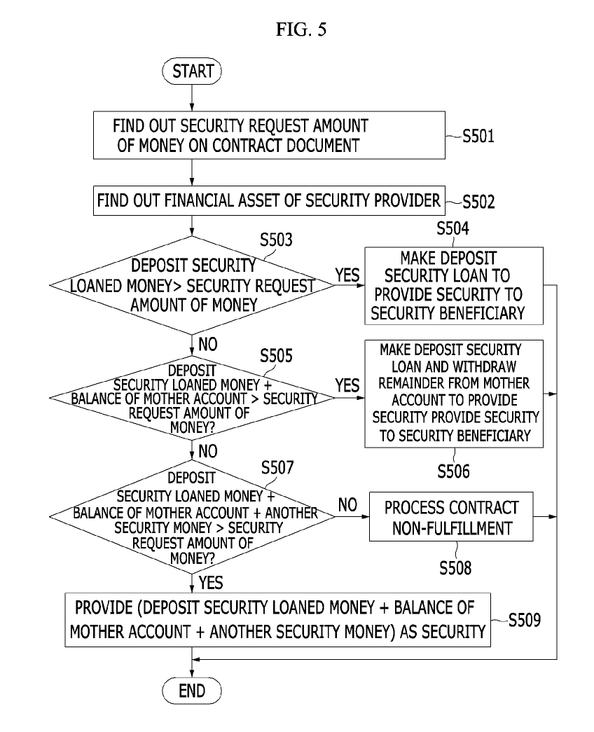

Hereinafter, a process of providing a security of the security provider to the security beneficiary, that is, a security right establishing process, according to an exemplary embodiment of the present invention will be described with reference to FIG. 5. FIG. 5 is a flow chart showing a process of providing a security of the security provider to the security beneficiary in the security transaction service method according to an exemplary embodiment of the present invention.

When registration of the contract document for the security transaction between the security beneficiary 11 and the security provider 12 is completed, the security transaction server 100 analyzes the contents of the contract document to find out a security request amount of money, thereby finding out whether or not a security right of a valuation amount of financial assets of the security provider 12 is established to be the security request amount of money or more (S501, S502).

The security transaction server 100 finds out the financial assets of the security provider 12 to decide whether or not a deposit security loaned money of the security provider 12 is the security request amount of money or more (S503).

Here, the financial assets are a time deposit, the balance of a general bankbook, an amount of money that may be loaned based on a security provided from a third party, and the like, of the security provider 12. Particularly, the amount of money that may be loaned based on the security provided from the third party is a real estate hypothec provided by the security provider 12 or a guarantee or a loaned money issued by requesting a loan using a guarantee provided from the third party to the security provider 12 as a security.

In addition, the deposit security loaned money is an amount of money that may be loaned using the deposit possessed by the security provider 12 as a security.

Here, the financial assets of the security provider 12 include a payment guarantee of the third party in addition to the asset of the security provider 12. This means that the security provider 12 serves as a security beneficiary of the third party. That is, this means that the security provider 12 may become the security beneficiary of the third party.

Meanwhile, according to an exemplary embodiment of the present invention, there is a sequence of establishing the security depending on a kind of financial assets of the security provider 12. That is, according to an exemplary embodiment of the present invention, the security is established in a sequence of a deposit, a mother account (the balance of the general bankbook), and another security (for example, a real estate hypothec, a payment guarantee, a fulfillment guarantee, or the like). According to another exemplary embodiment of the present invention, the security is not limited to being established in the above-mentioned sequence, but may be established in any sequence.

The security transaction server 100 decides whether or not the deposit security loaned money for the security deposit of the security provider 12 is the security request amount of money or more (S503). When the deposit security loaned money is the security request amount of money or more, the security transaction server 100 makes a deposit security loan for the deposit of the security provider 12 to provide the security to a security aggregation account of the security beneficiary 11 (S504).

A scheme of providing the security includes a scheme of depositing a cash loaned based on a deposit security as a deposit to provide the deposit as a pledge or a scheme of issuing a guarantee based on the deposit security and providing the guarantee to the security beneficiary. The meaning that the pledge or the guarantee is provided to the security beneficiary is to establish a manager of the pledge or the guarantee to the security beneficiary and manage identification information (for example, a pledge number or a guarantee number) for the pledge or the guarantee as financial information of the security beneficiary, and the contract document, the guarantee, the performance bond guarantee, or the like, is stored and managed as an electronic document in the security transaction server 100.

When the security right may not be established through the deposit security loan, the security transaction server 100 decides whether or not the sum of the loaned money of the deposit security loan of the security provider 12 and the balance of the mother account of the security provider 12 is the security request amount of money or more (S505).

When the sum of the loaned money of the deposit security loan and the balance of the mother account of the security provider 12 is the security request amount of money or more, the security transaction server 100 makes the deposit security loan and withdraws the remainder of the security request amount of money from the mother account of the security provider 12 to provide the security to the security beneficiary 11 (S506).

When the sum of the loaned money of the deposit security loan and the balance of the mother account is less than the security request amount of money, the security transaction server 100 decides whether or not the sum of the loaned money of the deposit security loan, the balance of the mother account, and a money that may be loaned using another security is the security request amount of money or more (S507).

When it is decided in S507 that a valuation amount is the security request amount of money or more, the security transaction server 100 creates a security through the security and the balance of the mother account and provides the created security to the security beneficiary 11 (S509). Here, the provided security is registered and managed in the security aggregation account of the security beneficiary 11.

When it is decided in S507 that the valuation amount is less than the security request amount of money, the security transaction server 100 decides that the contract is in a state in which it is not fulfilled to perform contract non-fulfillment processing (S508).

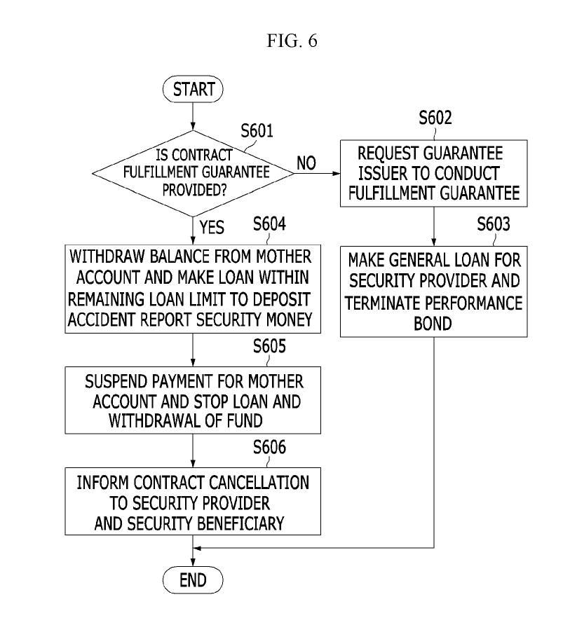

Hereinafter, a contract non-fulfillment processing process (S508) according to an exemplary embodiment of the present invention will be described with reference to FIG. 6. FIG. 6, which is a flow chart showing a processing process depending on contract non-fulfillment in the security transaction service method according to an exemplary embodiment of the present invention, shows the case for non-fulfillment of division security provision transaction contract of a security provider.

When it is decided that the contract is in the state in which it is not fulfilled, the security transaction server 100 decides whether or not a performance bond guarantee has been provided to the security provider 12 (S601).

When it is decided in S601 that the performance bond guarantee has been issued, the security transaction server 100 requests a guarantee issuer to performance bond guarantee to deposit a performance bond deposit in the mother account of the security provider 12 (S602).

Then, the security transaction server 100 generates a general loan for the security provider 12 and terminates the performance bond (S603).

Meanwhile, when it is decided in S601 that the performance bond guarantee has not been provided to the security provider 12, the security transaction server 100 withdraws the balance from the mother account of the security provider 12, makes a loan for the remainder of the security request amount of money except for the balance from the mother account withdrawn from the mother account based on the deposit or another security of the security provider 12 to generate a loaned money, and deposits the loaned money as an accident report security money for the security beneficiary 11 (S604).

Then, the security transaction server 100 suspends the payment for the mother account of the security provider 12, registers loan suspension of the security provider 12, and stops the withdrawal of the fund (S605).

Then, the security transaction server 100 considers that the contract of the security provider 12 is requested to be canceled to perform a contract cancellation procedure and then informs the security beneficiary 11 and the security provider 12 that the contract has been canceled depending on security provision non-fulfillment (S606).

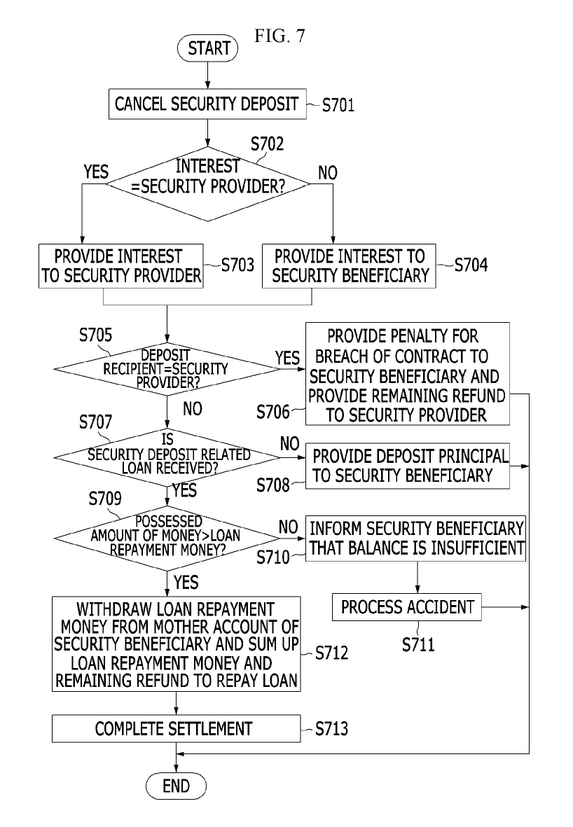

Hereinafter, a security right exercising process (S60) according to an exemplary embodiment of the present invention will be described in detail with reference to FIG. 7. FIG. 7, which is a flow chart showing a security deposit canceling process in a security right exercising process in the security transaction service method according to an exemplary embodiment of the present invention, shows the case in which a deposit is established as a security.

When a date becomes a security right expiration date or a contract cancellation request is received from the security beneficiary 11 and the security provider 12, the security transaction server 100 cancels a deposit established as a security (S701) in order to exercise a security right for a deposit.

The security transaction server 100 finds out a subject to which a generated interest is to be paid depending on the cancellation of the deposit through established information(S702), and provides the interest to the security provider 12 when the subject is the security provider 12 (S703) and provides the interest to the security beneficiary 11 when the subject is the security beneficiary 11 (S704).

Then, the security transaction server 100 finds out a recipient of an amount of money of the canceled deposit through established information (S705), and provides an amount of money corresponding to a penalty for breach of contract that the security beneficiary 11 is to receive in the amount of money of the canceled deposit to the security beneficiary 11 and deposits a remaining amount of money in the mother account of the security provider 12 (S706) when the recipient of the amount of money of the canceled deposit is the security provider 12.

In the case in which the recipient of the amount of money of the canceled deposit is the security beneficiary, the security transaction server 100 decides whether or not the security beneficiary has received a loan using the security right (S707), and deposits the amount of money of the canceled deposit (that is, a deposit principal) in the mother account of the security beneficiary 11 (S708) when the security beneficiary 11 has not received the loan using the security right.

When the security beneficiary 11 has received the loan using the security right, the security transaction server 100 evaluates the financial asset of the security beneficiary 11 to decide whether or not an amount of money possessed by the security beneficiary 11 is more than a loan repayment money (S709). Then, when the amount of money possessed by the security beneficiary 11 is less than the loan repayment money, the security transaction server 100 informs the security beneficiary 11 that the balance is insufficient (S710), and performs general financial accident processing (S711).

When the amount of money possessed by the security beneficiary 11 is more than the loan repayment money, the security transaction server 100 withdraws the loan repayment money from the mother account of the security beneficiary 11 and sums up the loan repayment money and the remaining refund to repay the loan (S712), and completes the exercise of a security right for the deposit, that is, security transaction settlement (S713).

Meanwhile, in the case of a security transaction for a middle payment money or an installment money, when S701 to S703 correspond to a security transaction for one installment money, the security transaction server 100 inquires of the security providers 12 whether or not to provide an additional security for the next installment money or middle payment money, and the additional security is registered in a list of security provision transactions when the security provider 12 admits provision of the additional security.

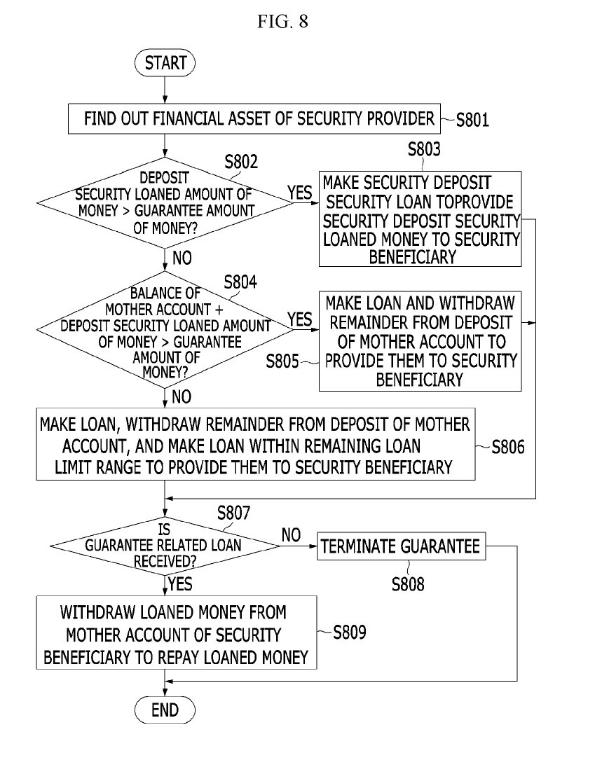

Hereinafter, an example of a guarantee processing process in the security right exercising process according to an exemplary embodiment of the present invention will be described with reference to FIG. 8. FIG. 8 is a flow chart showing a guarantee processing process in the security right exercising process in the security transaction service method according to an exemplary embodiment of the present invention.

The security transaction server 100 performs a guarantee fulfillment procedure for the security provider 12 depending on a guarantee when a date becomes an expiration date of the guarantee. To this end, the security transaction server 100 finds out a valuation amount of a financial asset of the security provider 12 (S801).

Here, the financial assets are a time deposit, the balance of a general bankbook, an amount of money that may be provided from a third party, and the like, of the security provider 12. Particularly, the amount of money that may be provided from the third party is a hypothec provided by the security provider 12 or a guarantee or a loaned money issued by requesting a loan using a guarantee provided from the third party to the security provider 12 as a security.

Here, the financial assets of the security provider 12 include an asset of the third party in addition to the asset of the security provider 12. This means that the security provider 12 serves as a security beneficiary of the third party. That is, this means that the security provider 12 may become the security beneficiary of the third party.

Meanwhile, according to an exemplary embodiment of the present invention, there is a sequence of fulfilling the security in the financial assets of the security provider 12. That is, according to an exemplary embodiment of the present invention, the security is fulfilled in a sequence of a deposit, a mother account (the balance of the general bankbook), and another security. According to another exemplary embodiment of the present invention, the security is not limited to being established in the above-mentioned sequence, but may be established in any sequence.

The security transaction server 100 decides whether or not the deposit security loaned money for the deposit of the security provider 12 is a guarantee amount of money or more (S802).

When the deposit security loaned money is the guarantee amount of money or more, the security transaction server 100 makes a deposit security loan for the deposit of the security provider 12 and deposits the deposit security loaned money in the mother account of the security beneficiary 11 (S803).

The security transaction server 100 decides whether or not the sum of the deposit security loaned money of the security provider 12 and the balance of the mother account of the security provider 12 is the guarantee amount of money or more (S804) when it is decided that the security may not be fulfilled through the deposit security loan.

When the sum of the deposit security loaned money and the balance of the mother account of the security provider 12 is the guarantee amount of money or more, the security transaction server 100 makes the deposit security loan to deposit a loaned money into the mother account of the security beneficiary 11, and withdraws the remainder of the guarantee amount of money from the mother account of the security provider 12 to deposit the remainder to the mother account of the security beneficiary 11 (S805).

When the sum of the deposit security loaned money and the balance of the mother account is less than the guarantee amount of money, the security transaction server 100 generates an amount of money corresponding to the guarantee amount of money through the deposit security loaned money, the balance of the mother account, and other security and deposits the generated amount of money in the mother account of the security beneficiary 11 (S806), in the case in which it is decided in S806 that a valuation amount is the guarantee amount of money or more.

When the guarantee fulfillment is processed through processes S801 to S806, the security transaction server 100 decides whether or not the security beneficiary 11 receives a loan using a guarantee (S807), and withdraws the guarantee and terminates the guarantee (S808) when the security beneficiary 11 does not receive the loan.

When it is decided in S807 that the security beneficiary 11 receives the loan using the guarantee, the security transaction server 100 withdraws a loaned money from the mother account of the security beneficiary 11 receiving a guarantee fulfillment billed money and repays the loaned money (S809).

An exemplary embodiment of the present invention described above is not implemented only by an apparatus and a method, but may also be implemented by a program realizing functions corresponding to components according to an exemplary embodiment of the present invention or a recording medium in which the program is recorded, which may be easily performed by those skilled in the art to which the present invention pertains from a description of an exemplary embodiment provided above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A security transaction service method comprising:
(a) a security transaction server providing a security transaction request document to a terminal of a security beneficiary depending on a request of the terminal of the security beneficiary;
(b) the security transaction server receiving a first security transaction request document in which information providing at least one of goods or services is written from the terminal of the security beneficiary to accept a security transaction request and registering the first security transaction request document in a list of security transaction requests;
(c) the security transaction server providing the list of the security transaction requests to a terminal of a security provider depending on a request of the terminal of the security provider;
(d) the security transaction server receiving contract documents concluded between the security beneficiary and the security provider from the security beneficiary and the security provider and registering the contract documents;
(e) the security transaction server establishing a security right by a security request amount of money for a financial asset of the security provider depending on contents of the contract documents;
(f) the security transaction server providing the established security right as a financial asset of the security beneficiary;
(g) the security transaction server exercising the security right on an expiration date of the security right or depending on a received contract termination request; and
(h) the security transaction server providing a dealing money depending on the exercise of the security right to an account of the security beneficiary.

2. The security transaction service method of claim 1, wherein:
the security right is at least one of a pledge, a guarantee, and a performance bond guarantee.

3. The security transaction service method of claim 2, wherein:
in the step (e),
the security right is established by the security request amount of money for a security deposit of the security provider in the case in which a deposit security loaned money of the security provider is the security request amount of money or more.

4. The security transaction service method of claim 2, wherein:
in the step (e),
the security right is established by the security request amount of money for a security deposit of the security provider and the balance of a mother account of the security provider in the case in which a deposit security loaned money of the security provider is less than the security request amount of money and a first amount of money corresponding to the sum of the deposit security loaned money of the security provider and the balance of the mother account of the security provider is the security request amount of money or more.

5. The security transaction service method of claim 2, wherein:
in the step (e),
the security right is established by the security request amount of money for the deposit security loaned money, the balance of the mother account, and another security in the case in which the first amount of money is less than the security request amount of money and a second amount of money corresponding to the sum of the deposit security loaned money, the balance of the mother account, and a loaned money obtained using another security is the security request amount of money or more.

6. The security transaction service method of claim 5, wherein:
in the step (d), the security transaction server provides and withdraws the contract documents to and from the terminal of the security beneficiary and the terminal of the security provider, compares the withdrawn contract documents with each other, and registers the contract documents simultaneously with concluding a contract in the case in which contents of the contract documents coincide with each other.

7. The security transaction service method of claim 1, wherein:
in the step (e),
the security right is established by the security request amount of money for a security deposit of the security provider in the case in which a deposit security loaned money of the security provider is the security request amount of money or more.

8. The security transaction service method of claim 7, wherein:
in the step (d), the security transaction server provides and withdraws the contract documents to and from the terminal of the security beneficiary and the terminal of the security provider, compares the withdrawn contract documents with each other, and registers the contract documents simultaneously with concluding a contract in the case in which contents of the contract documents coincide with each other.

9. The security transaction service method of claim 1, wherein:
in the step (e),
the security right is established by the security request amount of money for a security deposit of the security provider and the balance of a mother account of the security provider in the case in which a deposit security loaned money of the security provider is less than the security request amount of money and a first amount of money corresponding to the sum of the deposit security loaned money of the security provider and the balance of the mother account of the security provider is the security request amount of money or more.

10. The security transaction service method of claim 9, wherein:
in the step (d), the security transaction server provides and withdraws the contract documents to and from the terminal of the security beneficiary and the terminal of the security provider, compares the withdrawn contract documents with each other, and registers the contract documents simultaneously with concluding a contract in the case in which contents of the contract documents coincide with each other.

11. The security transaction service method of claim 1, wherein:
in the step (e),
the security right is established by the security request amount of money for the deposit security loaned money, the balance of the mother account, and another security in the case in which the first amount of money is less than the security request amount of money and a second amount of money corresponding to the sum of the deposit security loaned money, the balance of the mother account, and a loaned money obtained using another security is the security request amount of money or more.

12. The security transaction service method of claim 11, wherein:
in the step (d), the security transaction server provides and withdraws the contract documents to and from the terminal of the security beneficiary and the terminal of the security provider, compares the withdrawn contract documents with each other, and registers the contract documents simultaneously with concluding a contract in the case in which contents of the contract documents coincide with each other.

13. The security transaction service method of 3, wherein:
in the step (d), the security transaction server provides and withdraws the contract documents to and from the terminal of the security beneficiary and the terminal of the security provider, compares the withdrawn contract documents with each other, and registers the contract documents simultaneously with concluding a contract in the case in which contents of the contract documents coincide with each other.

14. The security transaction service method of claim 4, wherein:
in the step (d), the security transaction server provides and withdraws the contract documents to and from the terminal of the security beneficiary and the terminal of the security provider, compares the withdrawn contract documents with each other, and registers the contract documents simultaneously with concluding a contract in the case in which contents of the contract documents coincide with each other.

15. The security transaction service method of claim 1, wherein:
in the step (b),
the first security transaction request document includes a various condition information for a security transaction contract.

16. The security transaction service method of claim 1, wherein:
in the step (b),
the security transaction server notices security transaction collection contents.

17. The security transaction service method of claim 1, further comprising:
the security transaction server providing information of the first security transaction request document which is provided by the security beneficiary to the terminal of the security provider In case the security provider selects security transaction collection contents of the security beneficiary which is written in the list of security transaction requests, and
the security transaction server deciding the security provider as a security transaction applicant of the security beneficiary in case the security transaction server receives acceptance for the request of the security transaction collection of the security beneficiary from the terminal of the security provider.

18. The security transaction service method of claim 1, wherein:
in the step (e),
the security transaction server establishes a security period for the security right depending on the contents of the contract documents.
